(19) United States
(12) Patent Application Publication
(10) Pub. No.: US 2007/0011930 A1
(43) Pub. Date: Jan. 18, 2007

(54) Air-conditioner cover kit for seasonal use

(76) Inventor: Carol Yarmosh, Wheatley Heights, NY (US)

Correspondence Address: ALFRED M. WALKER, 225 OLD COUNTRY ROAD, MELVILLE, NY, 11747-2712, US

(21) Appl. No.: 11/394,300

(22) Filed: Mar. 29, 2006

Related U.S. Application Data
(60) Provisional application No. 60/666,145, filed on Mar. 29, 2005.

(51) Int. Cl. E06B 9/00; B65D 65/02; E06B 3/48; A47G 1/06

(52) U.S. Cl. 40/725; 150/165; 150/901; 160/127; 160/229.1

(57) ABSTRACT

An air conditioner cover kit used seasonally, includes a square or rectangular frame, which break down into a plurality of slats, which are joined together by fasteners such as brackets and screws. The frame can be broken down and snapped together with reusable hinges, such as those used in a bridge card table fastener configuration. The frame itself is used so that a typical picture frame can be adapted so that the picture can cover the unsightly air-conditioner during the wintertime when it is not in use. The air-conditioner cover insulates, blocking cold air from the outside. The cover can also match decorative motif in a room; it can simulate wallpaper/wall coverings or it can have a decorative image thereon. It can also have a mirror. It conserves energy, protects the adjacent room from cold outside air coming in and seals the house from air leaks.

### CROSS REFERENCE TO RELATED APPLICATIONS

This application also claims benefit under 35 U.S.C. 119(e) from provisional Application Ser. No. 60/666,145, filed Mar. 29, 2006, the entire disclosure of which is incorporated by reference herein. This application is also based upon a Disclosure Document filed Nov. 5, 2004.

### FIELD OF THE INVENTION

The present invention relates to seasonally assembled and disassembled air-conditioner cover kits.

### BACKGROUND OF THE INVENTION

Prior art includes fabric non-decorative covers for covering inside of an air-conditioner cover such as shown in the enclosed advertisement.

Non-breakdown air-conditioner one-piece covers are disclosed in U.S. Pat. No. 4,325,229 of DeZurik, U.S. Pat. No. 4,389,827 of Van Valkenburg and design U.S. Pat. No. 394,901 of Governale. However, these patents are one-piece units, which cannot be broken down and sold in a kit.

Known breakdown frames include snap together picture frames such as disclosed in U.S. Pat. No. 4,982,517 of Bilodau. However, Bilodau does not disclose a cover for an air conditioner that insulates the area.

Therefore, it would be useful to have an article, which covers the air conditioner during non-use because it is unsightly and insulates the air conditioner surface and the immediate vicinity from winter wind and weather passing through the air conditioner's venting system and its access to the outside air. The prior art does not disclose any of these advantages in one invention, therefore Applicant's present invention is not suggested by, but would be discouraged or taught away by the references relied on.

### OBJECTS OF THE INVENTION

This invention is a decorative indoor air-conditioner cover for use with through-wall type of AC units.

The objects of the invention are as follows:
prevent cold air leaks and drafts from outside during off-season periods when AC unit is not in use.
conserve energy by preventing heat loss during winter.
cover the AC unit with a decorative fabric or other means during non-use to improve appearance.
cover is easily removed, frame is knocked down or folded, and fabric cover material is folded or rolled up for easy storage.
cover can also be used as a decorative room divider when not used on AC unit.

It is therefore an object of the present invention to provide a cover for an air conditioner to prevent cold air leaks and drafts from outside air during winter months or non-use of the air conditioner.

It is also an object of the present invention to provide a cover, which conserves energy by preventing heat loss through the vents or outer walls that provide access to the outside air, while the air conditioner is not in use.

It is also an object of the present invention to cover an air conditioner while not in use, thereby eliminate the unsightly look of the air conditioner.

Other objects, which become apparent from the following description, of the present invention.

### SUMMARY OF THE INVENTION

In keeping with these objects and others, which may become apparent, the present invention is an air conditioner cover kit used seasonally, which includes a square or rectangular frame, which break down into a plurality of slats, which are joined together by fasteners such as brackets and screws.

In one embodiment, the frame can be broken down and snapped together with reusable hinges, such as those used in a bridge card table fastener configuration.

In another embodiment, the frame can be broken down and snapped together with flexible hinges.

The frame itself is used so that a typical picture frame can be adapted so that the picture can cover the unsightly air-conditioner during the wintertime when the air conditioner is not in use.

The air-conditioner cover insulates, blocking cold air from the outside. The cover can also match decorative motif in a room; it can simulate wallpaper/wall coverings or it can have a decorative image thereon. It can also have a mirror.

It conserves energy, protects the adjacent room from cold outside air coming in and seals the house from air leaks.

In a large version it can operate as a self-standing room divider.

The invention uses a rectangular frame such as four slats that can be attached by brackets and screws or snapped together with fasteners that snap together or can be folded into a linear arrangement using hinges when not in use. Fabric with an insulating backing can be attached over the frame using Velcro or snaps. A picture frame can also be attached on the front surface over the fabric. Multiple cover fabrics with different colors or patterns can be used on the same frame.

Another method of attaching fabric over the assembled frame is via long strips of extruded plastic which serve as fabric clips over the frame members.

Similar frame structures are snap-together picture frames and hinges and subassemblies from card tables.

As an accessory a compact disc is provided with instructions and super-imposed music as background relaxing music while the user assembles the air-conditioner cover.

The present invention has enhancements over the prior art, by incorporating the convenience of easy disassembly for off-season storage, the advantages of energy conservation and preventing air leaks and drafts, and use as an appliance cover over unsightly/ugly air conditioners, which may also be used to coordinate the air conditioner cover with other appliances or furniture in the room. The addition of re-useable hinges to assemble the frame of the air conditioner cover greatly enhances the utility and practicality of the frame by allowing it to be used when necessary, and easily and compactly stored when not in use, an important feature for most apartments, condos and homes.

The use of Applicant's invention also promotes energy conservation and limits and/or prevents drafts and air leaks so cold drafts do not enter the room though the air conditioner vents and/or spaces around the air conditioner's mounting location (whether it is mounted in a window or permanently fixed in a location through an outer wall) and heated air will not be lost via these conduits.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a head-on view of the frame for the Air-Conditioner Cover Kit For Seasonal Use in its disassembled form, and ready for storage.

FIG. 2 is a view of the interior portion of a partially assembled cover of the present invention attached to a picture frame.

FIG. 3 is an interior view of the present invention having decorative materials that are useful for insulating the air conditioner and its vicinity.

FIG. 4 is an exterior view of the present invention having removable, decorative materials that are useful for insulating the air conditioner and its vicinity.

FIG. 5 is a view of semi-assembled portions of the air conditioner cover.

FIG. 6 is an interior view of a typical picture frame to which the present invention may be attached.

FIG. 7 is a further view of a partially assembled air conditioner cover.

FIGS. 8 and 9 show assembled air conditioner covers of varying sizes.

FIG. 10 is a perspective view of an alternate embodiment for an assembled room divider constructed in accordance with the present invention.

FIG. 11 is an exploded view of a readily assembleable two piece room divider kit, which comes ready for assembly.

FIGS. 12A and 12B are close-up side elevational views showing clips removably attaching the fabric to the frame. The fabric is attached over the assembled frame is via long strips of extruded plastic which serve as fabric clips over the frame members.

FIG. 13 is an exploded perspective view showing the assembled frame of the air conditioner cover in front of an air conditioner to be covered.

FIG. 14 an exploded perspective view showing the assembled frame of the air conditioner cover in front of an air conditioner to be covered, shown forming a picture frame enclosing a fanciful figure therein.

FIG. 15 an exploded perspective view showing the assembled frame of the air conditioner cover in front of an air conditioner to be covered, shown as a fabric cover having a fanciful image thereon, wherein the fanciful image is wrapped around the assembled frame.

### DETAILED DESCRIPTION OF THE INVENTION

The present invention has broad applications to many technical fields for a variety of articles. For illustrative purposes only, especially as shown in FIGS. 13-15, a mode for carrying out the invention is described herein, wherein an air conditioner cover kit for seasonal use comprises a rectangular frame 10 that can be broken down into a plurality of slats 10a, 10b, 10c and 10d, and can be joined together by fasteners 14 such as brackets and screws. The slats 10a, 10b, 10c and 10d may be formed of any rigid, shape-retaining material, such as wood, plastic, heavy corrugated board, and the like.

While other variations may occur, in a typical use, a method is provided for seasonally covering and uncovering an air conditioner 12 extending through a wall 20 of a building, comprising the steps of:

a) measuring an outside perimeter of an inner face of an air conditioner 12;

b) measuring a depth of the air conditioner 12 from the inner indoor face rearward to the wall 20 into which the air conditioner 12 is inserted;

c) providing a frame 10 comprising a plurality of slats 10a, 10b, 10c and 10d, the slats being joinable together by fasteners 14;

d) measuring said set of slats from the plurality of slats 10a, 10b, 10c and 10d to form an outer frame 10, the set of slats 10a, 10b, 10c and 10d having respective joined inner edges being in positional register with the outer surface of the air conditioner 12, the slats 10a, 10b, 10c and 10d having a depth extending at least a portion of the depth of the air conditioner 12 from its inner exposed face rearward to the wall 20 into which the air conditioner 12 is inserted;

e) joining the slats 10a, 10b, 10c and 10d of the outer frame 10 of the air conditioner cover 11 with removable fasteners 14 to form side walls of the frame 10;

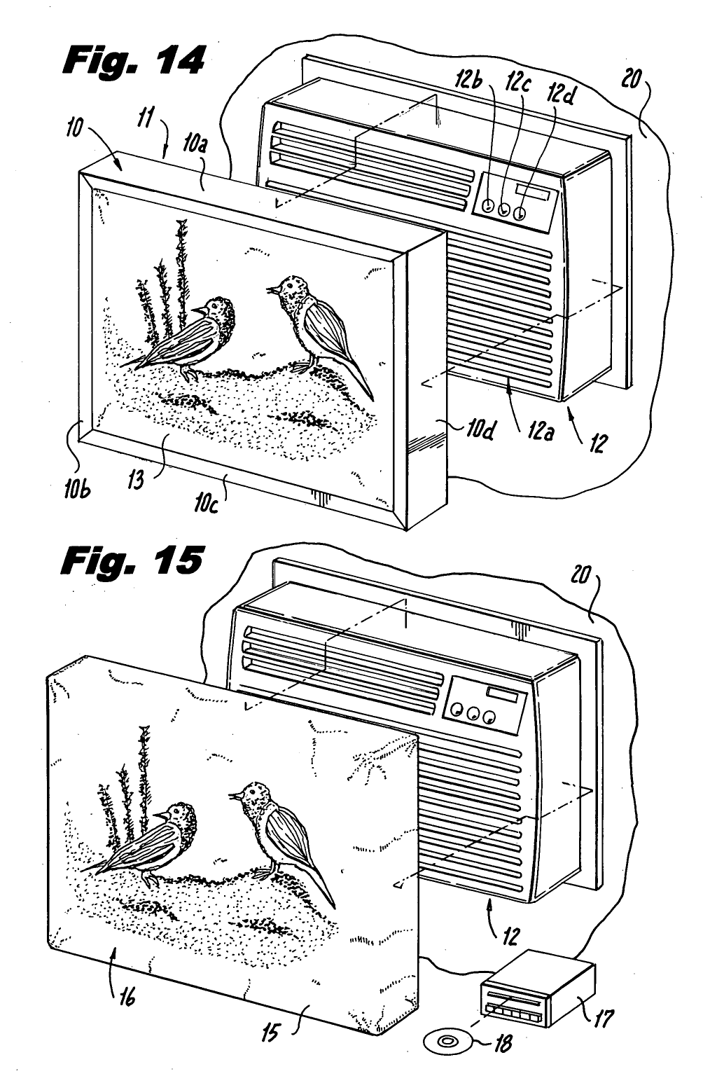

f) providing a decorative substrate 13 or 16 either within frame 10 as in FIG. 14 or over the outer frame 10 as in FIG. 15 and joining the decorative substrate 13 to the frame 10 with removable fasteners 14 or other fasteners;

g) leaving the air conditioner cover 11 over the air conditioner 12 during a seasonal time of non-use of the air conditioner 12;

h) breaking down the frame 10 into the plurality of slats 10a, 10b, 10c and 10d and exposing the air conditioner 12 for seasonal use; and,

i) placing together the plurality of slats 10a, 10b, 10c and 10d into a compact storage position.

The method of use can be enhanced by providing a user listenable media, such as, for example, a compact disc or DVD 18 within a player 17, with instructions and super-imposed music as background relaxing music while the user assembles and/or disassembles the air-conditioner cover 11.

In one embodiment, the frame 10 can be broken down and snapped together with card table fastener and hinges (not shown). The frame 10 itself is used so that a typical picture frame or stiffly-mounted picture 13 or 16, photo, painting, reproduction, fabric material and the like can be adapted so that the picture 13 or 16 can be set in the cover's slats 10a, 10b, 10c and 10d, framing the picture 13 or 16 and forming a open cube- like structure 11 to cover the unsightly air-conditioner 12 during the winter-time when the air conditioner 12 is not in use. The cover 11 may be lined with insulating batting 18 for additional insulation. In another embodiment, the frame 10 can be broken down and snapped together with fasteners 14, such as flexible hinges.

The addition of re-useable hinges 14 to assemble the frame 10 of the cover 11 greatly enhances the utility and practicality of the frame 10 by allowing it to be used when necessary, and then easily and compactly stored when not in use, an important feature for most apartments, condos and homes.

The cover 11 insulates the air conditioner vents and the spaces around the air conditioner 12, which allow access to the outside air. This insulating effect blocks cold air and drafts from entering a warm room or house through the vents or spaces. The present invention also has the advantage of conserving energy by preventing the cold air and drafts to enter a heated room or house.

The cover 11 may be used as an appliance cover over unsightly/ugly air conditioners 12. The cover 11 may also include decorative materials 13 or 16 to match the motif in a room; and/or, it may simulate wallpaper/wall-coverings or it can have a decorative image thereon. The cover 11 may also be a mirror or a favorite painting or print that is fitted into the cover frame 10.

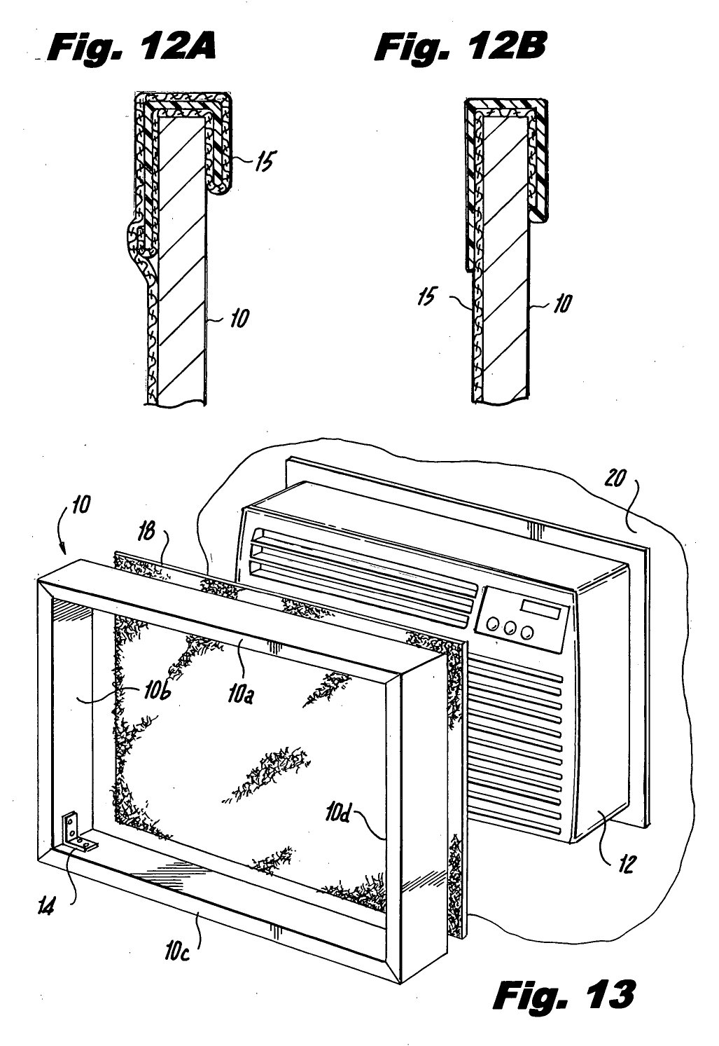

In a large version as shown in FIG. 11, the cover can operate as a self-standing room divider for use as a privacy screen, a noise screen or to divide a room space into segments, with clips for holding a fabric cover thereon, as shown in FIGS. 12A and 12B.

FIG. 13 shows an exploded perspective view of the assembled frame 10 of the air conditioner cover 11 in front of an air conditioner 12 to be covered. Frame 10 is made of removable slats 10a, 10b, 10c and 10d which are joined by fasteners 14. Frame 10 also functions as a picture frame for fanciful picture 14 enclosed therein, so that the unsightly appearance of the front grid 12a and operating knobs 12b, 12c and 12d is hidden by the fanciful picture 13 (shown in FIG. 14 within frame 10 of cover 11) and frame 10. It is noted that slats 10a, 10b, 10c and 10d may snugly fit over the outer perimeter surface of air conditioner 12, or a portion thereof. Additionally, in an option, the cover 11 may be larger than the outer perimeter of air conditioner 12 and attached by conventional wall fasteners to the wall 20 through which air conditioner 12 extends.

FIG. 14 an exploded perspective view showing the assembled frame 10 of the air conditioner cover 11 in front of the air conditioner 12 to be covered, shown forming a picture frame enclosing a fanciful FIG. 13 therein. FIG. 15 an exploded perspective view of an alternate embodiment where cover 15 is a fabric wrapping around frame 10, wherein fabric 15 has a fanciful image 16, which may optionally show depth via holographic or lenticular images thereon, giving the sense of three dimensional depth of the image 16 over air conditioner 12.

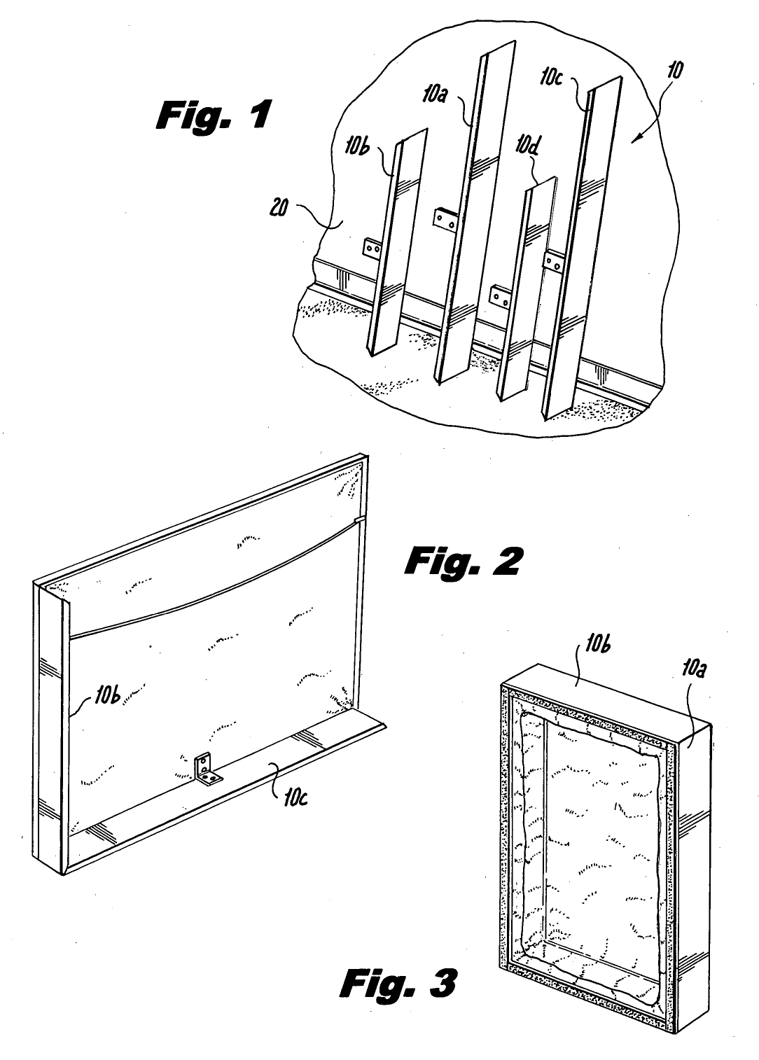

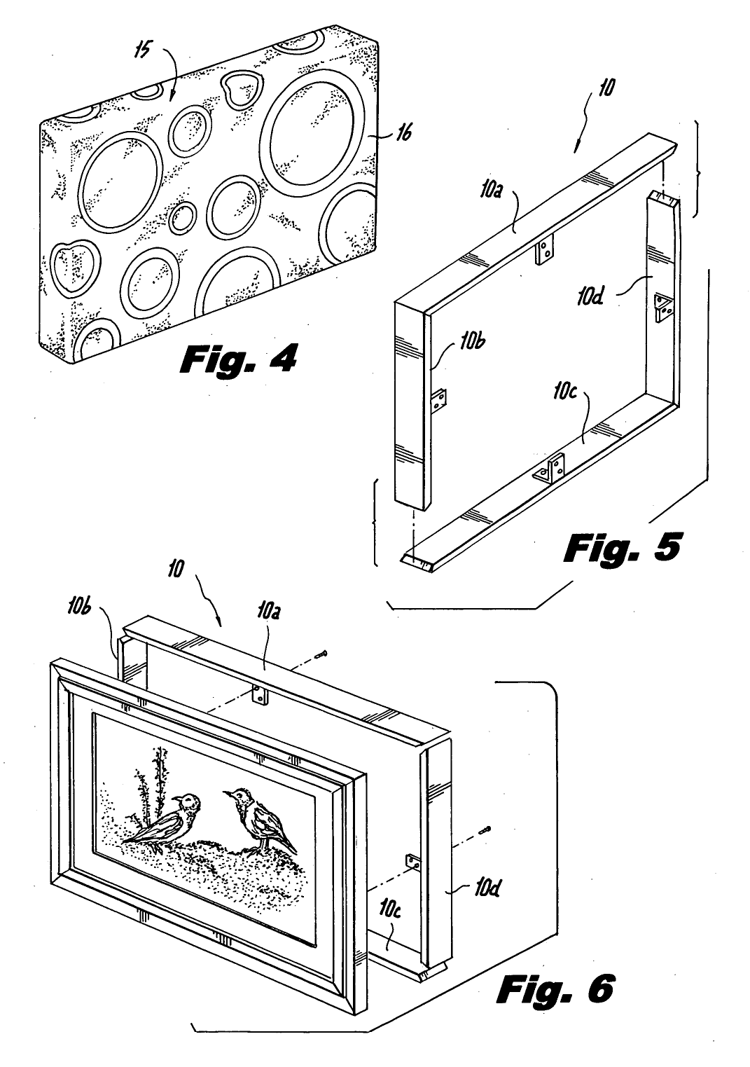

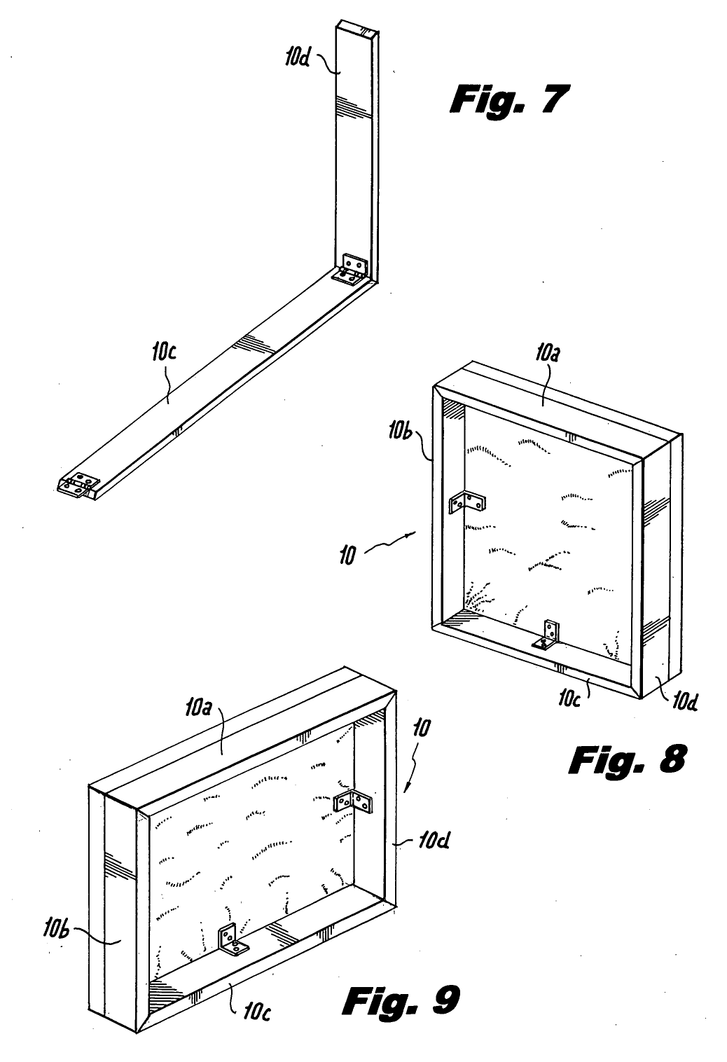

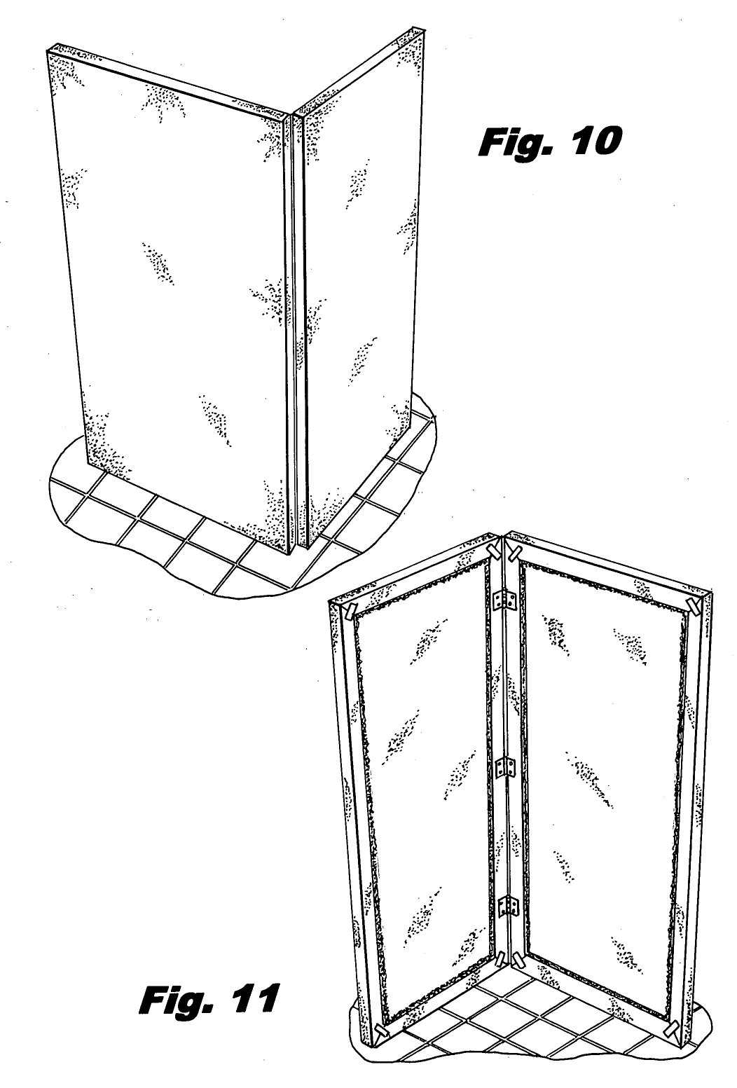

Optional compact disc player 17 for compact disc or DVD 18 may be provided for soothing music or for media instructions on how to assemble the frame 10 in the autumn season or how to disassemble the frame 10 in the spring season for storage over the air conditioning summer season. When disassembled, the slats 10a, 10b, 10c and 10d of frame 10 of air conditioner cover 11 can be stored compactly adjacent to each other, as shown in FIG. 1.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. An air-conditioner cover for seasonal use comprising: a frame having a plurality of slats removably attached to at least one other slat by re-useable fasteners, and a material removably attached to the slats.

2. An air conditioner cover of claim 1, wherein a plurality of slats are removably attached to other slats to form a closed shape.

3. An air conditioner cover of claim 1, wherein the shape formed by the plurality of slats frames the material.

4. An air conditioner cover of claim 1, wherein the material can be selected from a group consisting essentially of a photograph, a print, a painting, a reproduction of a painting, fabric material and batting.

5. An air conditioner cover of claim 4, wherein the material is stiffly mounted.

6. An air conditioner cover of claim 4, wherein the material is framed.

7. An air conditioner cover of claim 1, wherein the slats are formed of a rigid material.

8. An air conditioner cover of claim 7, wherein the slats are formed of wood.

9. An air conditioner cover of claim 7, wherein the slats are formed of plastic.

10. An air conditioner cover of claim 7, wherein the slats are formed of heavy corrugated board.

11. An air conditioner cover of claim 1, wherein the cover can be seasonally assembled for use.

12. An air conditioner cover of claim 11, wherein the cover can be seasonally disassembled for storage.

13. An air conditioner cover of claim 1 further comprising said attachable fabric material being inserted over said assembled frame and being attached to said assembled frame via longitudinally extending strips of extruded plastic serving as fabric clips over said assembled frame.

14. A room divider for temporary use comprising: a frame having a plurality of slats removably attached to at least one other slat by re-useable fasteners, and a material removably attached to the slats.

15. A room divider of claim 14, wherein a plurality of slats are removably attached to other slats to form a closed shape.

16. A room divider of claim 14, wherein the shape formed by the plurality of slats frames the material.

17. A room divider of claim 16, wherein the material can be selected from a group consisting essentially of a photograph, a print, a painting, a reproduction of a painting, fabric material and batting.

18. A room divider of claim 17, wherein the material is stiffly mounted.

19. A room divider of claim 17, wherein the material is framed.

20. A room divider of claim 14, wherein the slats are formed of a rigid material.

21. A room divider of claim 20, wherein the slats are formed of wood.

22. A room divider of claim 20, wherein the slats are formed of plastic.

23. A room divider of claim 20, wherein the slats are formed of heavy corrugated board.

24. A room divider of claim 14, wherein the cover can be temporarily assembled for use.

25. A room divider of claim 14, wherein the cover can be temporarily disassembled for storage.

26. A room divider of claim 14 further comprising said attachable fabric material being inserted over said assembled frame and being attached to said assembled frame via longitudinally extending strips of extruded plastic serving as fabric clips over said assembled frame.

27. A method of seasonally covering and uncovering an air conditioner extending inserted through a wall comprising the steps of:
a) measuring an outside perimeter of an inner face of an air conditioner;
b) measuring a depth of said air conditioner from said inner face rearward to said wall into which said air conditioner is inserted;
c) providing a frame comprising a plurality of slats, said slats being joinable together by fasteners;
d) measuring said set of slats from said plurality of slats to form an outer frame, said set of slats having respective joined inner edges being in positional register with the outer surface of said air conditioner, said slats having a depth extending at least a portion of said depth of said air conditioner from its inner face rearward to the wall into which said air conditioner is inserted;
e) joining said slats of said outer frame with removable fasteners to form side walls of said frame;
f) providing a decorative substrate to said outer frame and joining said decorative substrate to said frame with removable fasteners;
g) leaving said air conditioner cover over said air conditioner during a seasonal time of non-use of said air conditioner;
h) breaking down said frame into said plurality of slats and exposing said air conditioner for seasonal use; and,
i) snapping together said plurality of slats into a compact storage position.

28. The method of claim 27 further comprising the step of providing a user listenable media with instructions and super-imposed music as background relaxing music while the user assembles the air-conditioner cover.
